(19) United States
(12) Patent Application Publication
(10) Pub. No.: US 2013/0116164 A1
(43) Pub. Date: May 9, 2013

(54) PROCEDURE FOR CONDITIONING AND PERFUMING TREATMENT FOR TEXTILE ITEMS AFTER RINSING AND THE PRODUCT USED IN THIS PROCEDURE

(71) Applicant: INDUSTRIAS CATALA, S.A., Santa Margarida i els Monjos (Barcelona) (ES)

(72) Inventors: Manuel GIMENEZ MENESES, Barcelona (ES); Jose Luis PESCADOR BELLO, Barcelona (ES)

(73) Assignee: INDUSTRIAS CATALA, S.A., Santa Margarida i els Monjos (Barce (ES)

(21) Appl. No.: 13/621,417

(22) Filed: Sep. 17, 2012

(30) Foreign Application Priority Data
Sep. 15, 2011 (ES) 201131494

(51) Int. Cl. C11D 3/50; C11D 3/00

(52) U.S. Cl. CPC C11D 3/50; C11D 3/001
USPC 510/516

(57) ABSTRACT

The invention comprises a procedure for conditioning and perfuming textiles and a product suitable for carrying out this procedure, with a long-lasting persistence of the perfuming effect in the garments. The procedure comprises the phases for obtaining a solid product that comprises a hydrosoluble core and an enveloping layer composed by at least one water-soluble softening active ingredient. These ingredients have water-soluble surface activity, adjuvants and perfumes. The procedure also includes the phases of dosing the solid treatment product at a concentration between 0.2 and 15 g/1 of treatment liquid, the application of the solid and the washing water in rinsing phase at pH between 3 and 10.

### FIELD OF THE INVENTION

The present invention is a procedure for conditioning and perfuming treatment for textile items after the rinsing phase, also referring to the product used for this treatment.

### STATE OF THE ART

For many years, when washing textile items, especially domestic garments, different types of products for textile washing and conditioning are used. These are habitually applied during the machine-washing phase, as well as in manual washing.

The objectives of the products used for conditioning and washing textile items are multiple, and thus there are a large variety of them.

In many cases, the intention has been to achieve a washing action, i.e., an action using detergent, with a simultaneous conditioning action for the textile items. This conditioning includes functions destined to achieve different objectives, such as avoiding garment creasing, achieving surface touch effects on the user's skin without abrasive action, preserving the colours of items or reviving some of these colours, prolonging the life of the garment, achieving greater physical consistency of the garment, perfume effects, etc. For this reason, there are many patents destined to cover different types of products that have some of the aforementioned objectives or others.

Due to the simultaneous action of the different components of the washing and conditioning products during the washing process, it is difficult to obtain optimum effects of all the ingredients used. Due to their long experience in the sector, the inventors were aware that one of the effects that users most desire and that is difficult to preserve after the washing and conditioning phases is the perfuming effect on garments. Perfuming of garments is one of the features most clearly perceived by the user and which gives the washing and conditioning of the garments a greater perceived quality when worn by the user, either when they are first put on as well as during the time they are worn. The perfumed character of the garment is, according to the inventors' experience, the feature most immediately appreciated by users, especially those who are not usually involved in the washing process of garments and do not have much appreciation of other specific factors in the washing operation such as whiteness, brightness of colours, etc. which are more perceptible to those who did the washing and drying and in some instances the ironing of the garments. In all cases, garment smell perception of is a sensorial quality factor that is immediately appreciated by many users.

Nonetheless, achieving, in addition to a good wash, an effective and long-lasting perfuming effect in the garment, is hard and expensive, due to the cost of the ingredients, especially in the case of a mixture with a single washing and conditioning compound.

### DESCRIPTIONOF THE INVENTION

This invention is based on research carried out by the inventors, according to which it is possible to achieve a high level of persistence of the perfuming effect in washed and conditioned garments when the following phases are successively implemented:
i. obtaining a solid product for treating textile items in the form of beads or granules, comprising a hydrosoluble core and an enveloping layer composed of at least one active ingredient, soluble or water dispersible softener, active ingredients with surface activity soluble or dispersible in water, adjuvants and perfumes, so that
   a) the core is firstly covered with a pre-mix of the liquid ingredients and then with another pre-mix of the rest of the solid ingredients for the formation of the solid treatment granules with a single but stratified layer,
   b) granules measuring 0.15-5 mm average diameter are obtained;
   c) the hydrosoluble core is present in an amount that represents 45-95% w/w of the total weight of the solid product,
ii. the solid treatment product is dosed at a concentration of 0.2-15 g/1 of treatment liquid, preferably 0.8-5 g/l,
iii. the solid beads or granules are applied to the washing water, with a pH of 2-11;
iv. the pH of the solution made with the treatment solid and the washing water in rinsing phase is preferably between 3 and 10.

The beads or granules formed in this procedure have a density of 0.7 to 1.3 g/cm³ at 20 ° C. and a non-volatile dry extract at 105 ° C. of 80-99% w/w.

The treatment procedure for conditioning and perfuming textiles, according to this invention has shown surprising effects in the maintenance and release of the perfuming product and especially by greater fixing and permanence of the perfuming agents in the fibres of the textile items. The effect is achieved particularly by placing the coating layer of the granules in a single but stratified layer by the prior application of a pre-mix with the liquid ingredients and then another pre-mix with the rest of the solid ingredients.

For the hydrosoluble core, the most effective ingredients are metal salts of organic and inorganic acids, inorganic acids, quaternary ammonium salts, water soluble polymers, carbohydrates, urea and mixtures of these, so that the proportion of hydrosoluble core in the composition is preferably between 45 and 95% w/w and more preferably 70-90o w/w of total weight.

Referring to the active softener ingredients, quaternary ammonium salts, silicones, quaternary polymers, clays or mixtures of them were used. These active softener ingredients are in the composition in a proportion 2-40% w/w, more preferably 7-20% w/w of the total weight of the composition.

The rest of the active ingredients with surface activity are selected preferably among anionic surfactants, non-anionic surfactants, amphoteric surfactants, soaps, water/oil (W/O) emulsions as a whole or their emollients, emulsifiers and humectants particularly oil/water (O/W) emulsions as a whole or their emollients, emulsifiers and humectants, particularly polyethylene glycols and mixtures of them. These active ingredients with surface activity are in the composition in a proportion 1.5-15% w/w, more preferably 2-9% w/w of the total weight of the composition.

The adjuvant agents that optimise the detersive properties were selected from the group comprising the presentation auxiliaries, filler agents, chemical whitening agents, optical whiteners, corrosion inhibitors, antiredeposition agents, colorant transfer inhibitors, pearling agents, opacifiers, secuestrants, products for care of fibres (vegetable extracts, waxes, hydrocarbons, vitamins, proteins, etc.), anti-agglomerants, disintegration agents, desiccants, preservatives, antioxidants, colouring agents, antistatic agents, auxiliaries for ironing or mixtures of them, as well their derivatives, so that their percentage in the composition is 0.1-10% w/w, more preferably 1.5-5% w/w of the total product weight.

The perfuming agents were selected according to this invention between mixtures of low activity organic and/or natural chemical products which are formulated by the perfumist according to the properties of the final product so they will be perceived in any of the 3 phases of a fragrance, which according to William Poucher are head, body and depth. The head of the perfume will be formulated with the most volatile products, the body with those of medium volatility and those of depth have the greatest molecular weight and less volatile elements. Within the organic compounds, the functional most commonly used groups are: aldehydes, esters, alcohols and acids, both cyclic and acyclic of molecular weights less than 300, such as: D-Limonene, Isobornyl acetate, Aldehyde cyclamen, Styrallyl acetate, Lilial, Hedione, Geraniol, Phenylethyl alcohol, Alpha ionone, Benzyl acetate, Dihydromyrcenol and Linalool. With regard to raw materials of natural origin, oils from of many parts plants (leaves, stalk, roots etc.) are used, such as: Anis star oil, Basil oil, Peppermint oil, Spearmint oil, Benzoin, Cistus absolute, Olibanum oil, Tolu balsam, Citronella oil, etc.

These simple or complex compositions of natural and artificial ingredients are found in a proportion of 0.1-15% w/w of total weight of the composition, more preferably 1.5% -6% w/w.

It has been observed that the application of the procedure purpose of this invention achieves a greater fixing of the perfuming agents in the textile fibres of the items treated as well as greater permanence of the perfuming effect.

### DESCRIPTION OF THE DRAWINGS

FIG. 1 is a graph showing the results of the conditioning test prepared for example 1 of embodiment of the solid product.

FIG. 2 is a graph showing the results of the conditioning test prepared for example 2 of embodiment of the solid product.

FIG. 3 is a graph showing the results of the conditioning test prepared for example 3 of embodiment of the solid product.

FIG. 4 is a graph showing the results of the conditioning test prepared for example 4 of embodiment of the solid product.

FIG. 5 is a graph showing the results of the conditioning test prepared for example 5 of embodiment of the solid product.

FIG. 6 is a graph showing the results of the conditioning test prepared for example 6 of embodiment of the solid product.

FIG. 7 is a graph showing the results of the conditioning test prepared for example 7 of embodiment of the solid product.

FIG. 8 is a graph showing the results of the conditioning test prepared for example 8 of embodiment of the solid product.

### EXAMPLES

The following examples illustrate preferred embodiments of the present invention and do not intend at all to limit its scope.

Procedure for preparing a solid product.

For producing the solid product for the examples shown below, selective stratification was carried out, which allows the sequential deposit of the different ingredients to be deposited in the washing bath at ambient temperature, without it being necessary to warm and/or melt any ingredient, mixture or pre-mixture during the entire manufacturing process.

The ingredients mentioned here are expressed in weight percentage with regard to the total compound weight.

Initially, a homogenous mixture of the ingredients presented in liquid form is made at ambient temperature. Phosphonates at a concentration of 1.2% w/w, perfume at a concentration of 4% w/w, and colorants at a concentration of 0.007% w/w. The liquid mixture is added very slowly to the beads of urea added at a concentration of 86.4% w/w, gently stirring the result to maintain the integrity of the granules resulting from this layer enveloping the core. Then, Tetrapotassium Pyrophosphate (TKPP) is premixed homogenously at a concentration of 0.15% w/w of Sodium triphosphate (STPP), Polyvinylpyrrolidone at a concentration of 0.5% w/w, and methyl hydroxypropyl cellulose at a concentration of 0.2% w/w, which are added onto the previous layer, creating a new differentiated layer. Small amounts of amorphous silica at a concentration of 0.1% w/w and polysiloxane at a concentration of 0.2% w/w are added onto this layer. Finally, the granules obtained are sprinkled with clay at a concentration of 7% w/w in order to create the final layer.

The product is presented as opaque granules of different colours, very stable in time, pouring easily without forming clumps that could make dosing difficult.

Other solid products were prepared for use in the procedure of the invention, which were prepared following the procedure described above in the present section.

### Example 1

The product has the following ingredients expressed in weight percentage with regard to the total compound weight.; Tetrapotassium pyrophosphate (TKPP) 7%, perfume 1%, amorphous silica 0.5%, clay 2%, phosphonates 0.1%, sodium Lauryl sulphate 1.2%, cocamidopropyl betaine 0.1%, Polyvinylpyrrolidone (PVP) 1%, colouring agent 0.007%, methyl hydroxypropyl cellulose 1%, sodium chloride 86.1%.

### Example 2

The product has the following ingredients expressed in weight percentage with regard to the total compound weight: sodium Triphosphate (STPP) 0.5%, sodium silicate 1%, perfume 2.5%, Amorphous silica 0.3%, phosphonates 0.2%, polysiloxane 0.3%, sodium lauryl sulphate 1%, colouring agent 0.007%, Carboxtmethyl cellulose 1%, sodium sulphate 93.2%.

### Example 3

The product has the following ingredients expressed in weight percentage with regard to the total compound weight; Tetrapotassium pyrophosphate (TKPP) 0.25%, STPP 0.15%, perfume 4%, amorphous silica 0.1%, phosphonates 1.2%, polysiloxane 0.2%, Polyvinylpyrrolidone (PVP) 0.5%, colouring agent 0.007%, methyl hydroxypropyl cellulose 0.2%, urea 86.4%.

### Example 4

The product has the following ingredients expressed in weight percentage with regard to the total compound weight: Tetrapotassium pyrophosphate (TKPP) 10%, sodium silicate 7%, perfume 3%, phosphonates 0.15%, polysiloxane 1%, sodium lauryl sulphate 0.1%, Polyvinylpyrrolidone (PVP) 0.8%, colouring agent 0.007%, methyl hydroxypropyl cellulose 1%, sodium carbonate 76.9%.

### Example 5

The product has the following ingredients expressed in weight percentage with regard to the total compound weight; Tetrapotassium pyrophosphate (TKPP) 5%, perfume 2%, clay 9%, phosphonates 0.3%, sodium lauryl sulphate 0.5%, Polyvinylpyrrolidone (PVP) 1.5%, PEG 35000 1%, colouring agent 0.0007%, methyl hydroxypropyl cellulose 0.5%, sodium citrate 80.2%.

### Example 6

The product has the following ingredients expressed in weight percentage with regard to the total compound weight: Sodium triphosphate (STPP) 5%, sodium silicate 2%, perfume 6%, amorphous silica 0.2%, clay 2%, phosphonates 0.6%, polysiloxane 0.8%, cocamidopropyl betaine 1%, PEG 35000 2%, colouring agent 0.007%, carboxymethyl cellulose 1%, starch 79.4%.

### Example 7

The product has the following ingredients expressed in weight percentage with regard to the total compound weight: Sodium triphosphate (STPP) 8%, sodium silicate 1%, perfume 3%, amorphous silica 0.5%, phosphonates 0.1%, sodium lauryl sulphate 0.4%, cocamidopropyl betaine 0.8%, Polyvinylpyrrolidone (PVP) 1%, colouring agent 0.007%, carboxymethyl cellulose 2%, dextrose 83.2%.

### Example 8

The product has the following ingredients expressed in weight percentage with regard to the total compound weight:

sodium silicate 0.2%, perfume 2.5%, Amorphous silica 0.15%, clay 10%, phosphonates 0.15%, polysiloxane 0.1%, Sodium lauryl sulphate 0.25%, cocamidopropyl betaine 0.1%, Polyvinylpyrrolidone (PVP) 1.2%, colouring agent 0.007%, sucrose 85.3%.

### Perfuming and Conditioner Tests of Garments.

Using the procedure purpose of the present invention and adding the solid product for fabric treatment in the form of beads or granules, substantially improves the sensory properties obtained when using conventional laundry detergent for washing clothes, reinforcing the perfuming conditioning power on the clothes.

### Perfuming Test

A test was carried out by a panel of experts trained to determine the permanence and long-lasting effect of the aromatic composition.

This method uses a group of highly trained evaluators (perfumist and professional evaluators with experience in the creation, evaluation and selection of fragrances) carrying out sensory tests (olfactory) on different types of fabrics: 100% cotton, 60% cotton and 40% polyester mix, and 100% polyester, to which the procedure is applied and the product suitable for the procedure purpose of the present invention.

Testing was carried out in three phases: wet clothes, sniff and dry clothes, and in each of them, the objectives were as follows: to measure the pleasantness and power of the fragrance after having been washed (wet phase, measure the pleasantness and power of the fragrance (sniff) and measure the substantivity of the power, evaluating the degree and the power when dry (dry clothing).

The results were classified as powerful, quite powerful, average, weak and very weak.

Table 1 shows the results when carrying out the test using the product of example 3 in the procedure of the invention in two different concentrations, and they are compared with the results obtained by carrying the same test with a state of the art (SA) product.

TABLE 1

| | SNIFF | | DAMP | | DRY 24 H | | DRY, 4 DAYS | | |
|---|---|---|---|---|---|---|---|---|---|
| Samples | A | P | A | P | A | P | A | P | AVG |
| Compound | 4.02 | 4.08 | 3.93 | 4.03 | 3.7 | 3.55 | 3.92 | 3.88 | 3.89 |
| SA- Oriental | | | | | | | | | |
| Frag. | | | | | | | | | |
| Example | 4.02 | 4.17 | 4.03 | 4.23 | 3.71 | 3.69 | 4.08 | 4 | 3.99 |
| 3 - 2% | | | | | | | | | |
| Frag. A | | | | | | | | | |
| Example | 4.08 | 4.2 | 4.07 | 4.23 | 3.98 | 3.7 | 4.32 | 4.32 | 4.11 |
| 3 - 3% | | | | | | | | | |
| Frag. A | | | | | | | | | |
| Compound | 4 | 4 | 3.9 | 4.4 | 3.66 | 3.63 | 4.05 | 4.1 | 3.97 |
| SA- Floral | | | | | | | | | |
| Frag. | | | | | | | | | |
| Example | 4.12 | 4.22 | 3.67 | 4.17 | 3.96 | 4.1 | 4.2 | 4.18 | 4.08 |
| 3 - 2% | | | | | | | | | |
| Frag. B | | | | | | | | | |
| Example | 3.87 | 4.25 | 3.93 | 4.57 | 3.99 | 4.24 | 4.23 | 4.32 | 4.18 |
| 3 - 3% | | | | | | | | | |
| Frag. B | | | | | | | | | |

A: Pleasantness; P: Power; AVG: Average

The results showed that when using the products of the invention, the pleasantness and power values in the dry garments 4 days after the application of the procedure were superior to those displayed by similar state of the art (SA) products.

### Conditioning Test

A panel of 21 trained users evaluated 10 parameters of the washed clothes using the procedure object of the invention and each of the variations of solid products of the invention shown in the examples of embodiment. These variations of solid products were added to neutral unperfumed detergents and were compared to conventional neutral unperfumed detergents without including the solid product.

The parameters to be measured were optical appearance, sliding power, waste formation, sponginess, elasticity, body to the touch, comfort in use, softness, drying efficacy and the formation of fluff or pilling. Formation of fluff or pilling occurs when different loose strands of the fabrics join together.

In the test, paired comparative washing studies were carried out using a normal wash cycle with a 75 g dose of neutral unperfumed laundry detergent in a washing machine with 4.5 kg of clothes, together with 40 g of each of the products which conform the examples of embodiment (1-8) of this invention, locating the pentameter scale of results between the −1 and the +1; where each line shows a paired comparison in a variable.

The sample space is the ordinal scale (−1; −0.5; 0; +0.5; +1) (Wilcoxon Test with a p-value <=0.1). If adding the solid product of the invention to the laundry detergent improves the performance of the conventional laundry detergent, the value is to the right of the value 0, namely, +0.5 or +1. However, if adding the solid product of the treatment to the laundry detergent worsens the performance of the conventional laundry detergent, the value is on the left of the value 0, namely, −0.5 or −1.

The results obtained in these tests are shown in table 2.

TABLE 2

| | Examples | | | | | | | |
|---|---|---|---|---|---|---|---|---|
| Parameters | 1 | 2 | 3 | 4 | 5 | 6 | 7 | 8 |
| Optical | 0.5 | 0 | 0 | 0 | 0.5 | 0.5 | 0.5 | 0.5 |
| appearance | | | | | | | | |
| (irregular) | | | | | | | | |
| Sliding power | 1 | 0.5 | 1 | 0.5 | 1 | 1 | 1 | 1 |
| (slower) | | | | | | | | |
| Waste formation | 0 | 0.5 | 0.5 | 0 | 0 | 0 | 0 | 0 |
| (more) | | | | | | | | |
| Body to the touch | 0.5 | 0.5 | 0.5 | 0.5 | 1 | 1 | 1 | 0 |
| (less) | | | | | | | | |
| Elasticity (less) | 1 | 0.5 | 1 | 1 | 0.5 | 1 | 1 | 0.5 |
| Sponginess (less) | 1 | 1 | 1 | 0.5 | 1 | 1 | 1 | 1 |
| Comfort in use | 0.5 | 0.5 | 1 | 0 | 0.5 | 1 | 0.5 | 0.5 |
| (less) | | | | | | | | |
| Softness (less) | 1 | 1 | 1 | 0.5 | 1 | 1 | 1 | 1 |
| Formation of | 0 | 0 | 0.5 | 0 | 0.5 | 0 | 0.5 | 0.5 |
| fluff (more) | | | | | | | | |
| Drying efficacy | 0 | 0 | 0.5 | 0 | 0 | 0 | 0 | 0 |
| (less) | | | | | | | | |

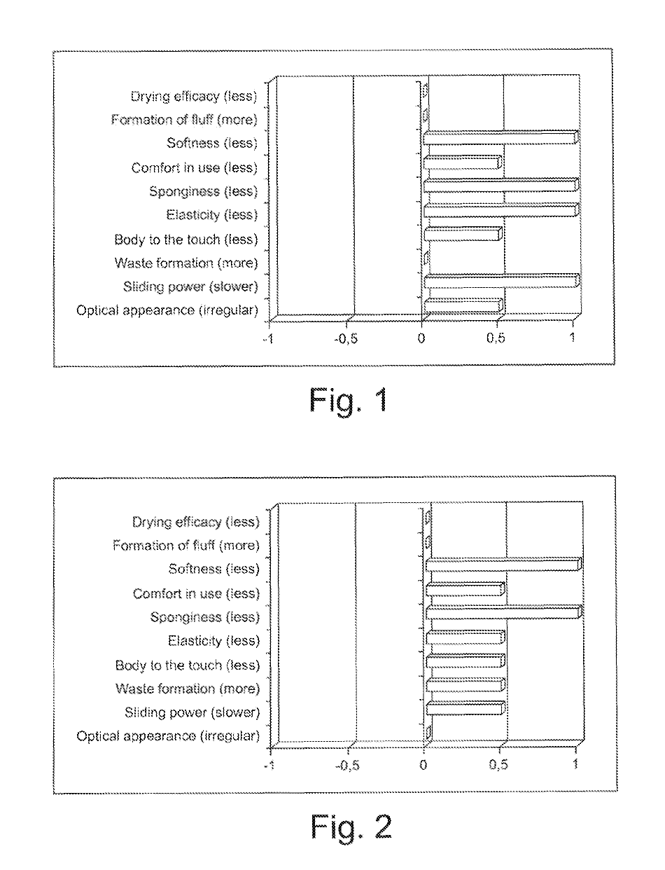

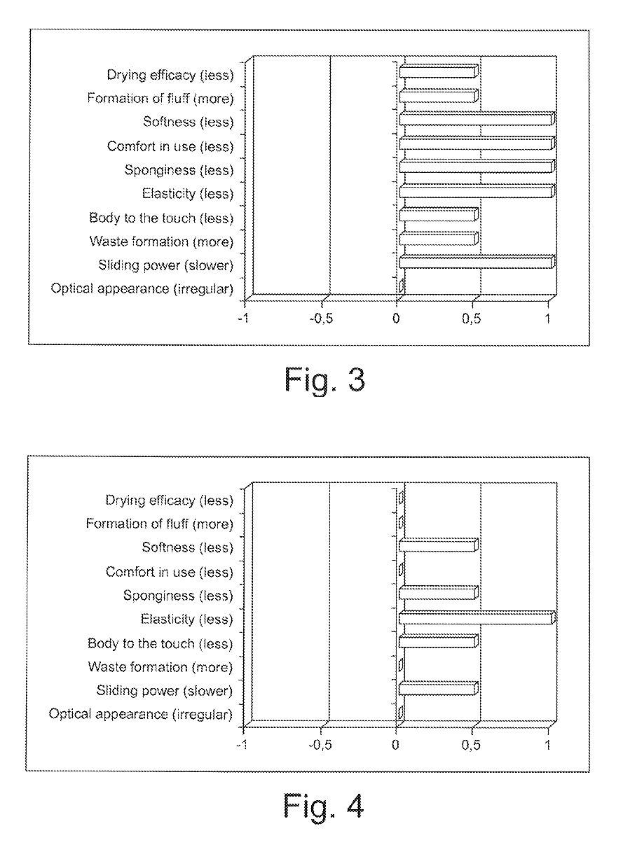

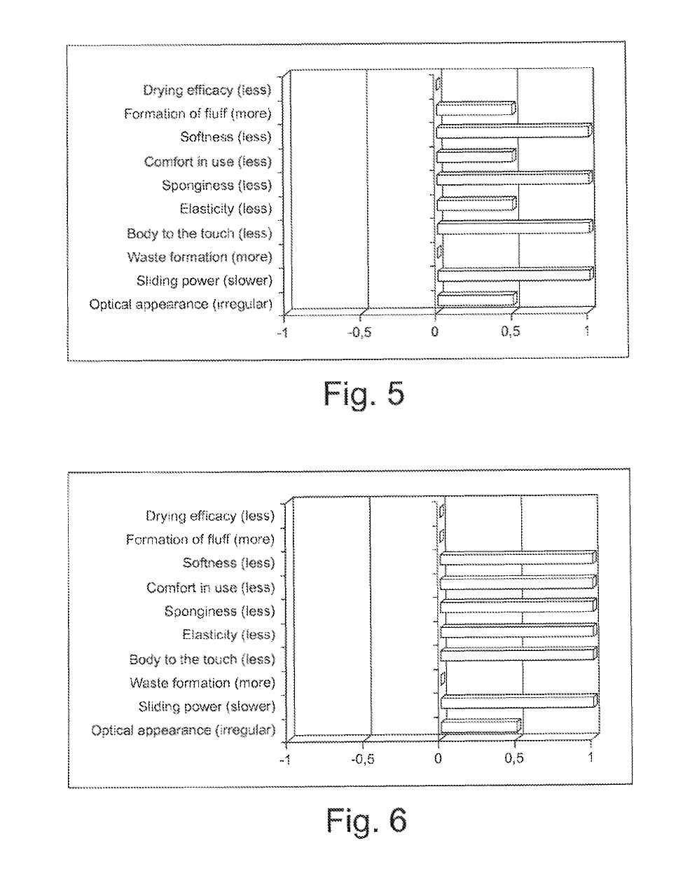

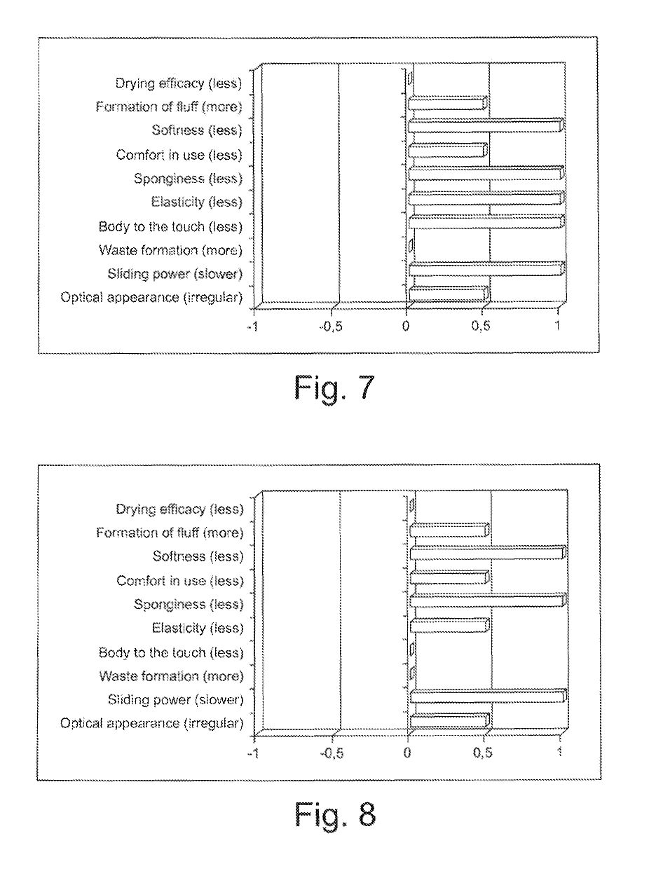

The results shown in table 2 are represented graphically in FIGS. 1-8 for their better visualisation.

On studying the results shown in FIGS. 1-8, we can observe that the example with the best global performance is number 3, especially outstanding in the sections of softness, comfort, sponginess in use, elasticity and sliding, whereas in the rest of parameters evaluated there are also good results, although lower than the above, with the exception of optical impression, which remains the same. Very close to these are the results achieved in example 7, highlighting improvement in formation of fluff and the body to the touch in detriment of comfort in use. Special mention can be made of the results obtained in example 6, quite different, in the sense that they do not present a global line with an average evaluation. Then, and in this order, we can see a decrease in performance obtained by the different examples, although all of them are still significantly better than the results obtained when washing with conventional neutral laundry detergent: 5-1-8-2-4.

Although the invention has been described with regard to its specific features and specified percentages of the ingredients to be used, it can be seen that in view of the material presented in this description, examples and claims, the technicians making the material could introduce multiple variations within the scope of the invention comprised in the present claims.

In addition, it must be understood that the examples of composition for the product to carry out the procedure of the invention are also destined to the better understanding of the invention and the way to make it, but not as a limitation. It must also be understood that weight percentages with regard to weight are indicative of the optimum compositions at this moment the invention was developed, but they could vary to a greater or lesser degree (within certain limits) from these indicated values.

1. Procedure for conditioning and perfuming treatment for textile items comprising, successively, the following phases:
i. obtaining a solid product for treating textile items in the form of beads or granules, comprising a hydrosoluble core and an enveloping layer composed of at least one active ingredient, soluble or water dispersible softener, active ingredients with surface activity soluble or dispersible in water, adjuvants and perfumes, so that
the core is firstly covered with a pre-mix of the liquid ingredients and then with another pre-mix of the rest of the solid ingredients for the formation of the solid treatment granules with a single but stratified layer,
granules measuring 0.15-5 mm average diameter are obtained;
the hydrosoluble core is present in an amount that represents 45-95% w/w of the total weight of the solid product,
ii. the solid treatment product is dosed at a concentration of 0.2-15 g/1 of treatment liquid, preferably 0.8-5 g/l,
iii. the solid beads or granules are applied to the washing water, with a pH of 2-11;
iv. the pH of the solution made with the treatment solid and the washing water in rinsing phase is preferably between 3 and 10.

2. Product for the embodiment of the procedure of claim 1, characterised in that the hydrosoluble core is chosen from a group constituted by metal salts of organic and inorganic acids, quaternary ammonium salts, water soluble polymers, carbohydrates, urea and mixtures of them.

3. Product according to claim 2, characterised in that the hydrosoluble core is present in the product in an amount that represents 45-95% w/w, more preferably 70-90% w/w of the total weight of the product.

4. Product for the embodiment of the procedure of claim 1, characterised in that the active softener ingredients, quaternary ammonium salts, silicones, quaternary polymers, bentonites or mixtures of them were used.

5. Product according to claim 4, characterised in that the active softener ingredients are in the compound in a proportion 2-40% w/w, more preferably 7-20% w/w of the total weight of the compound.

6. Compound for the embodiment of the procedure of claim 1, characterised in that the rest of the active ingredients with surface activity are selected among anionic surfactants, non-anionic surfactants, amphoteric surfactants, soaps, water/oil (W/O) emulsions as a whole or their emollients, emulsifiers and humectants particularly oil/water (0/W) emulsions as a whole or their emollients, emulsifiers and humectants, particularly polyethylene glycols and mixtures of them.

7. Product according to claim 6, characterised in that the active ingredients with surface activity are in the composition in a proportion 1.5-15% w/w, more preferably 2-9% w/w of the total weight of the compound.

8. Product for the embodiment of the procedure of claim 1, characterised in that the adjuvant agents to optimize the detersive properties were selected from the group comprising the presentation auxiliaries, filler agents, chemical whitening agents, optical whiteners, corrosion inhibitors, antiredeposition agents, colorant transfer inhibitors, pearling agents, opacifiers, secuestrants, products for care of fibres (vegetable extracts, waxes, hydrocarbons, vitamins, proteins, etc.), anti-agglomerants, disintegration agents, desiccants, preservatives, antioxidants, colouring agents, antistatic agents, auxiliaries for ironing or mixtures of said compounds, as well their derivatives.

9. Product according to claim 8, characterised in that the adjuvant agents are in the compound in a proportion 0.1-10% w/w, more preferably 1.5-5% w/w of the total weight of the compound.

10. Product for the embodiment of the procedure of claim 1, characterised in that preferably it comprises: amorphous silica between 0.1 and 1.2%; clay between 2 and 10%; phosphonates between 0.1 and 1.2%; polysiloxane between 0 and 0.8%; PVP between 0 and 1.2%; perfuming agents between 1 and 6%, and a hydrosoluble core formed by one of; sodium chloride, sodium sulphate, urea, sodium carbonate, sodium citrate, starch, dextrose and sucrose.

11. Product according to claim 10, characterised in that the component of the hydrosoluble core is between 75 and 95% w/w.

12. Product according to claim 10, characterised in that it further comprises Tetrapotassium Pyrophosphate (TKPP) and sodium Triphosphate (STPP).

13. Product according to claim 10, characterised in that it further comprises sodium silicate between 0.1 and 7% w/w.

14. Product according to claim 10, characterised in that it further comprises polyethylene glycol (PEG) 35000 between 1 and 2% w/w.

15. Product according to claim 10, characterised in that it further comprises methyl hydroxypropyl cellulose between 0.1 and 2% w/w.

16. Product according to claim 10, characterised in that it further comprises carboxymethyl cellulose between 1 and 2% w/w.
